(19) United States
(12) Patent Application Publication
(10) Pub. No.: US 2024/0054410 A1
(43) Pub. Date: Feb. 15, 2024

(54) CASTING DIRECTOR MESSAGING AND ALERT SYSTEM AND RELATED METHODS

(71) Applicant: STAGER INTELLECTUAL PROPERTIES, LLC, ORLANDO, FL (US)

(72) Inventor: Chaz KRIVAN, Orlando, FL (US)

(21) Appl. No.: 18/383,990

(22) Filed: Oct. 26, 2023

Related U.S. Application Data
(63) Continuation-in-part of application No. 16/906,175, filed on Jun. 19, 2020, now abandoned.
(60) Provisional application No. 62/863,371, filed on Jun. 19, 2019.

(51) Int. Cl. G06Q 10/02; G06F 3/0482

(52) U.S. Cl. CPC G06Q 10/02; G06F 3/0482

(57) ABSTRACT

A computer implemented casting director messaging and alert method includes transmitting to a first mobile computing device a plurality of productions stored in a memory in response to receiving, by a machine intelligence application running on one or more processors, a request from a user. The method includes prompting, via a graphical user interface on the first mobile computing device, the user to select one of the productions from the plurality of productions. The method also includes comparing, by the machine intelligence application, data of available actors to a respective actor characteristics model for the selected production, and transmitting to the first mobile device, in response to determining the predictive actors, pictures of the predictive actors corresponding to the selected production. The method includes transmitting, to a second mobile computing device corresponding to the at least one selected predictive actor, an electronic invitation to audition or the selected production.

### RELATED APPLICATIONS

This application is a continuation in part of U.S. application Ser. No. 16/906,175 filed Jun. 19, 2020, which is related to U.S. Provisional Patent Application Ser. No. 62/863,371 filed Jun. 19, 2019, the entire contents of which are incorporated herein by reference.

### TECHNICAL FIELD

The present invention relates to the field of casting and auditions for the entertainment industry, and, more particularly, to a casting director messaging and alert system and related methods.

### BACKGROUND

The audition process for a casting director is time consuming and logistically difficult to schedule. It begins with typically making lists of audition times for interested actors, making phone calls and sending emails to schedule the auditions. Then once the auditions have been scheduled, the casting director will take notes and rate each of the auditions in order to help determine whether a call back is warranted for a particular actor.

Once the audition has concluded, the casting director will review the notes and ratings to select the actors that have made it further in the audition process. The actors are again contacted to them know they have been selected and the scheduling process continues for more auditions until all the parts are filled.

The rating of the auditions for the actors and additional scheduling of call backs, or notifying actors that they did not get the part is generally time consuming and there is no universal standard of communication between the actors and casting directors. Accordingly, there is a need to develop a casting director messaging and alert system that is universal and allows for a way to schedule auditions, rate and sort auditions, and communicate with the actors that is less time consuming and more efficient.

### SUMMARY

A casting director messaging and alert system is disclosed. The system includes a memory, a plurality of actor characteristics models corresponding to a respective plurality of productions, the plurality of actor characteristics stored in the memory. One or more processors are coupled to the memory and configured to execute computer-readable programming instructions to perform operations. The operations include transmitting to a first mobile computing device the plurality of productions stored in the memory to the user, and prompting, via a graphical user interface on the first mobile computing device, the user to select one of the productions from the plurality of productions. The operations also include receiving from the first mobile computing device the selected production, running a machine intelligence application on the one or more processors to compare data of available actors to the respective actor characteristics model for the selected production, and responsive to comparing the data of the available actors to the respective actor characteristics model, determining which of the available actors are predicted actors by using probabilistic neural network algorithms. The system includes determining the predictive actors, pictures of a plurality of available actors corresponding to the selected production and stored in the memory, and prompting, via the graphical user interface on the first mobile computing device, the user to select at least one of the predictive actors using the pictures of the plurality of actors. In addition, the operations include transmitting, to a second mobile computing device corresponding to the at least one selected predictive actor, an electronic invitation having a unique code for an appointment to an audition for the selected production, and receiving from the second mobile device of the selected predictive actor an invitation response to the electronic invitation. The operations include generating, in response to receiving the audition response from the selected predictive actor, an electronic ticket that comprises the unique code for entry to the appointment by the selected predictive actor, and transmitting the electronic ticket to the second mobile computing device of the selected predictive actor.

The operations may also include scanning the electronic ticket displayed on the second mobile computing device to determine if it matches the electronic invitation when presented to the first mobile computing device at the audition. The operations may include displaying a plurality of profiles associated with the predictive actors on the first mobile computing device, and include prompting, via the graphical user interface on the first mobile computing device, the user to tag the pictures into a first pass category or a second fail category after the audition and provide feedback from the audition. In addition, the operations may include transmitting, to the second mobile computing device corresponding to the at least one selected predictive actor, an electronic audition decision corresponding to the tagged category, the electronic audition decision having a textual message generated using artificial intelligence prompted by the feedback from the audition. The operations may include receiving from the second mobile device of the selected predictive actor an audition response to the audition decision. The invitation response may comprise an alert automatically displayed on the first mobile computing device when received.

The probabilistic neural network algorithms are programmed to include non-traditional gender castings in determining which of the available actors are predicted actors. The operations sending and receiving user messaging, via the graphical user interface of the first mobile computing device, with the plurality of actors, and generating a calendar to display on the first mobile computing device of each audition appointment. The operations may include generating a resume using artificial intelligence in response to verbal input from one of the available actors, the resume stored in the data of available actors. The operations may also include generating an audition for the selected production using artificial intelligence.

In another aspect a computer implemented casting director messaging and alert method is disclosed. The method includes transmitting to a first mobile computing device a plurality of productions stored in a memory in response to receiving, by a machine intelligence application running on one or more processors, a request from a user. The method includes prompting, via a graphical user interface on the first mobile computing device, the user to select one of the productions from the plurality of productions, and receiving from the first mobile computing device the selected production. The method includes comparing, by the machine intelligence application, data of available actors to a respective characteristics model for the selected production. The method also includes transmitting to the first mobile device, in response to determining the predictive actors, pictures of the predictive actors corresponding to the selected production and stored in the memory. The method includes prompting, via the graphical user interface on the first mobile computing device, the user to select at least one of the predictive actors, and transmitting, to a second mobile computing device corresponding to the at least one selected predictive actor, an electronic invitation having a unique code for an appointment to an audition for the selected production. In addition, the method includes receiving from the second mobile device of the selected predictive actor an invitation response to the electronic invitation, generating, in response to receiving the audition response from the selected predictive actor, an electronic ticket that comprises the unique code for entry to the appointment by the selected predictive actor, and transmitting the electronic ticket to the second mobile computing device of the selected predictive actor.

In another aspect, a non-transitory machine-readable medium having stored thereon machine-readable instructions executable to cause operations is disclosed. The operations include transmitting to a first mobile computing device a plurality of productions stored in a memory in response to receiving, by a machine intelligence application running on one or more processors, a request from a user. The operations include prompting, via a graphical user interface on the first mobile computing device, the user to select one of the productions from the plurality of productions, and receiving from the first mobile computing device the selected production. The operations also include comparing, by the machine intelligence application, data of available actors to a respective actor characteristics model for the selected production. In addition, the operations include transmitting to the first mobile device, in response to determining predictive actors by using probabilistic neural network algorithms, pictures of the predictive actors corresponding to the selected production and stored in the memory, and prompting, via the graphical user interface on the first mobile computing device, the user to select at least one of the predictive actors The operations include transmitting, to a second mobile computing device corresponding to the at least one selected predictive actor, an electronic invitation having a unique code for an appointment to an audition for the selected production. The operations also include receiving from the second mobile device of the selected predictive actor an invitation response to the electronic invitation, generating, in response to receiving the audition response from the selected predictive actor, an electronic ticket that comprises the unique code for entry to the appointment by the selected predictive actor, and transmitting the electronic ticket to the second mobile computing device of the selected predictive actor.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram illustrating an embodiment of a casting director messaging and alert system in which various aspects of the disclosure may be implemented;

FIG. 2 is a block diagram of the system;

FIG. 3 is a flowchart illustrating a method of operating the system illustrated in FIG. 1;

FIG. 4 is a diagram illustrating different screens of a graphical user interface (“GUI”) of the system illustrated in FIG. 1;

FIGS. 5-9 are particular screens of the GUI shown in FIG. 4;

FIG. 10 is a general flowchart of the method of operating the system illustrated in FIG. 1; and

FIGS. 11-20 are detailed flowcharts of particular aspects of the method shown in FIG. 10.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one of skill in the art upon reading the following disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMS, optical storage devices, magnetic storage devices, and/or any combination thereof.

The casting director messaging and alert system and method is universal and allows for a way to schedule auditions, rate and sort auditions, and communicate with the actors that is less time consuming and more efficient than has been accomplished before.

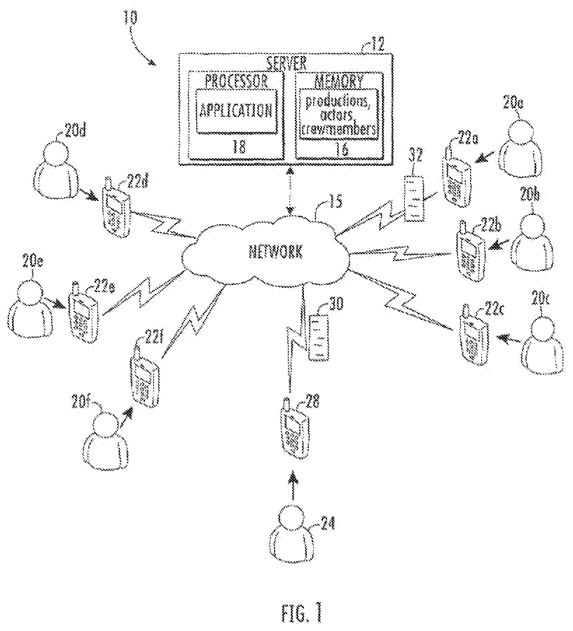

Referring initially to FIG. 1, a non-limiting network environment is illustrated 10 in which various aspects of the disclosure may be implemented and includes one or more mobile computing devices. For example, a first mobile computing device 28 of a casting director 24 communicates with second mobile computing devices 22a-22f of available actors 20a-20f via network 15. The casting director 24 can use a graphical user interface (“GOI”) displayed on the first mobile computing device 28 to operate the application 14. The GUI may be a touchscreen, a display, etc. and one or more input/output (I/O) devices such as a mouse, a keyboard, a microphone, one or more speakers, one or more cameras, one or more biometric scanners, one or more environmental sensors, and one or more accelerometers, etc.

The network 15 may be configured in any combination of wired and wireless networks. For example, in some embodiments, the network 15 may be: a local-area network (LAN); a metropolitan area network (MAN); a wide area network (WAN); a primary public network; and a primary private network. Additional embodiments may include a network 15 of mobile telephone networks that use various protocols to communicate among mobile devices. For short range communications within a WLAN, the protocols may include 802.11, Bluetooth, and Near Field Communication (NFC). The network 15 is also configured to transmit an electronic ticket 32 that comprises a unique code for entry to the appointment for an audition to the second mobile computing device 22a. Similarly, the network 15 is configured to transmit an invitation response 30 and other alerts to the first mobile computing device 28.

A server 12 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; or a server executing an application acceleration program that provides firewall functionality, application functionality, or load balancing functionality.

The server 12 may execute, operate or otherwise provide an application that may be any one of the following: software; a program; executable instructions; a virtual machine; a hypervisor; a web browser; a web-based client; a client-server application; a thin-client computing client; an Activex control; a Java applet; software related to voice over internet protocol (VOIP) communications like a soft IP telephone; an application for streaming video and/or audio; an application for facilitating real-time-data communications; a HTTP client; a FTP client; an Oscar client; a Telnet client; or any other set of executable instructions.

The server 12 includes one or more processors 18 coupled to a memory 16. The memory 16 may be configured to store data about each of the productions and actor and/or crewmember information, contact information, pictures, etc.

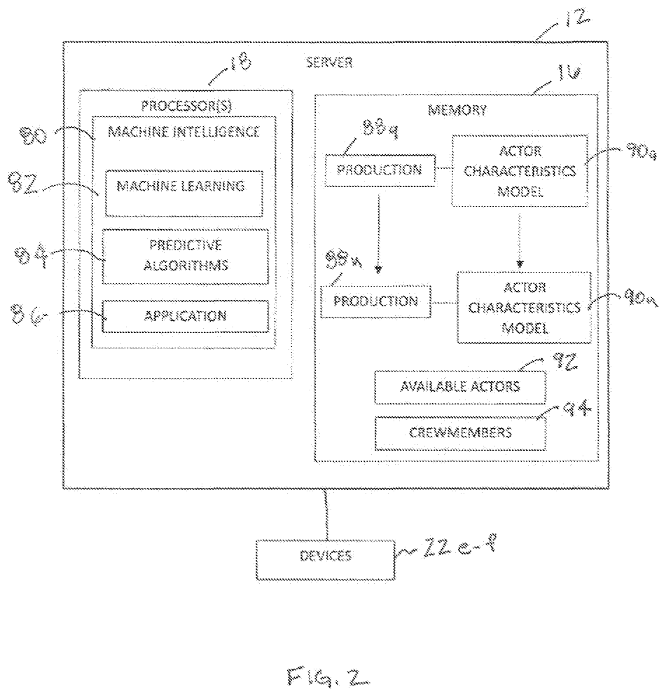

Turning to FIG. 2, a block diagram of the casting director messaging and alert system 10 is depicted in accordance with an illustrative embodiment. The system 10 comprises a server 12 and devices 22e-f.

The server 12 comprises processors 18, and machine intelligence 80. Machine intelligence 80 includes machine learning 82, predictive algorithms 84, and an application 86.

Machine intelligence 80 can be implemented using one or more systems, such as an artificial intelligence system, a neural network, a Bayesian network, an expert system, a fuzzy logic system, a genetic algorithm, or other suitable types of systems. Machine learning 82 and predictive algorithms 84, in addition to other elements and programs, such as application 86, make the server 12 a special purpose computer for a casting director messaging and alert system.

Predictive algorithms 84 may be configured for use by machine intelligence 80 to use patterns and anomalies, as well as numerical values, statistical weights for determining whether a particular available actor is likely to succeed at an audition for a particular production.

The memory comprises a plurality of productions 88a-(n), each associated with an actor characteristics model 90a-(n). The memory 16 also includes available actors 92 and crewmembers, for example. The actor characteristics model comprises the characteristics of each role for a particular production. For example, this can include the need for an actor based on a particular gender, age range, physicality (short, tall, thin, heavy, light, dark), job title (mom, lawyer, cop, spy, teen, criminal), personality traits (quirky, serious, intellectual, sexy, loud, innocent).

Predicted actors comprise those available actors that are matched for a particular production by comparing data of the characteristics for the role with their listed characteristics. This is done by a machine intelligence application running on the one or more processors, to compare the available actors 92 to the respective actor characteristics model 90a-(n) for the selected production 88a-(n), Which of the available actors are determined to be predicted actors is accomplished by using probabilistic neural network algorithms that compare the data of the available actors 92 to the respective actor characteristics model 90a-(n) and identify the actor(s) that is most likely to be awarded the role.

The machine or artificial intelligence of the system is configured to automate emails and push notification messages to the available actors. This would function in response to whether an actor is accepted for a role or not. When an actor is selected, the system is configured to automatically generate and send a congratulatory email. Conversely, if an actor is not selected, the system is configured to generate an email or a message via push notification offering feedback based on a star rating from an audition as explained in more detail below.

For example, if an actor does not get a role, the email or push notification sent out is tailored by machine intelligence to consider the lowest and highest ratings the actor received during the audition. The content of the message highlights these specific points of strength and areas of improvement, generating a comprehensive and personalized feedback.

In addition, the machine intelligence 80 of the system is configured to assist directors in creating auditions. In this context, the machine intelligence 80 is configured to “fill in the blanks” for a particular production. For example, if a director is putting together an audition for the musical “Grease”, the system is configured to pull the synopsis, character list, and age range requirements automatically. This simplifies the preparation process for directors so that the system is user-friendly.

In addition, the machine learning 82 may be configured so that it supports a more diverse casting by suggesting alternatives such as non-traditional gender casting to improve diversity in the industry.

The machine intelligence can also be used by the available actors to create a resume to reduce the tedious process of inputting extensive information manually. Instead, an available actor provides an oral prompt to the machine intelligence 80, and it is configured to generate a professional resume. For example, the actor could prompt: “I recently got cast in the show ‘True West’ in Orlando, Florida at the Shakespeare Center. I also did the musical ‘RENT’, where I played the role of Mark, and a Shakespeare show called ‘Romeo and Juliet’, where I played Mercutio. All three of these were actually at the Shakespeare Center.” The machine intelligence is configured to use this information to craft a comprehensive resume, removing the burden of resume creation from the user.

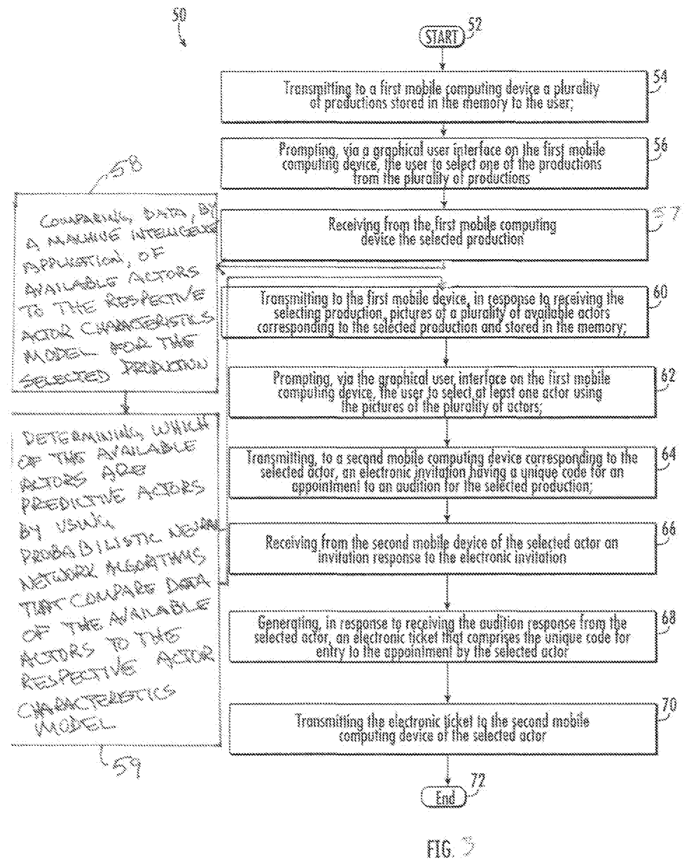

FIG. 3 is a general flowchart illustrating a method 50 of operating the system of FIG. 2. The method begins, at 52, and includes transmitting to a first mobile computing device a plurality of productions stored in the memory to the user, at 54. The method also includes, at 56, prompting, via a graphical user interface on the first mobile computing device, the user to select one of the productions from the plurality of productions. Moving to 57, the method includes receiving from the first mobile computing device the selected production, and, at 58, comparing data, by a machine intelligence application, of available actors to the respective actor characteristics model for the selected production. The method includes, at 59, determining which of the available actors are predictive actors by using probabilistic neural network algorithms that compare data of the available actors to the respective actor characteristics model. At 60, the method includes transmitting to the first mobile device, in response to receiving the selected production, pictures of a plurality of available actors corresponding to the selected production and stored in the memory.

In addition, the method includes prompting, via the graphical user interface on the first mobile computing device, the user to select at least one actor using the pictures of the plurality of actors, at 62, and transmitting, to a second mobile computing device corresponding to the selected actor, an electronic invitation having a unique code for an appointment to an audition for the selected production, at 64. The method also includes, at 66, receiving from the second mobile device of the selected actor an invitation response to the electronic invitation, and generating, in response to receiving the audition response from the selected actor, an electronic ticket that comprises the unique code for entry to the appointment by the selected actor, at 68. The method includes transmitting, at 70, the electronic ticket to the second mobile computing device of the selected actor, and the method ends at 72,

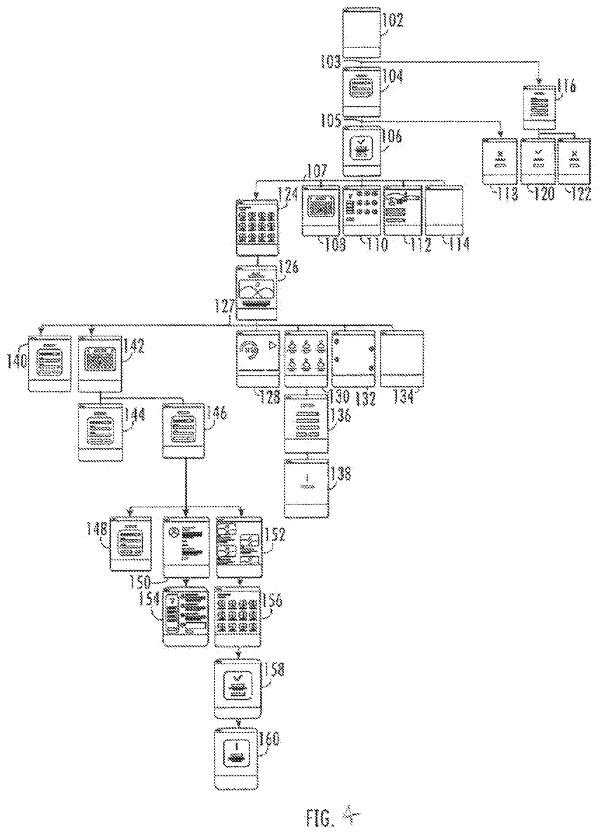

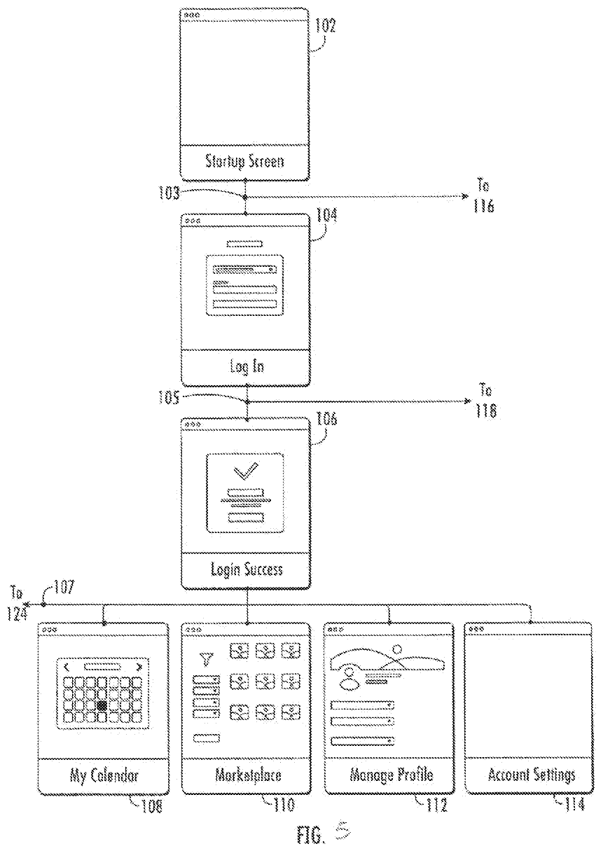

Referring now to FIG. 4, a general diagram of a particular embodiment of the casting director messaging and alert system is disclosed and generally designated 100. In operation, the system 100 begins with a startup screen 102, as shown in FIG. 5, and allows the user to login 104. If the login indicates success 106, then the user can access a calendar 108, marketplace 110, manage profile 112, and account settings 114, interfaces.

If the user has no account, then the user can

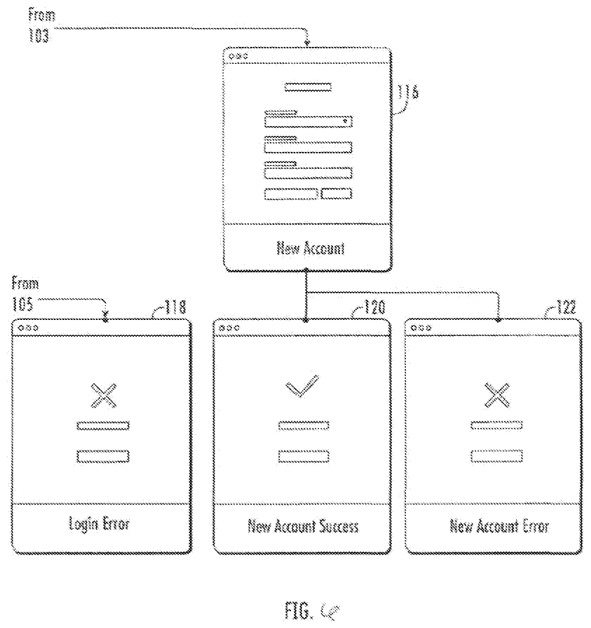

create a new account 116, as shown in FIG. 6. A screen is displayed that indicates new account success 120 or a new account error 122. If the user has an account, a login error screen 118 is displayed when there is a problem.

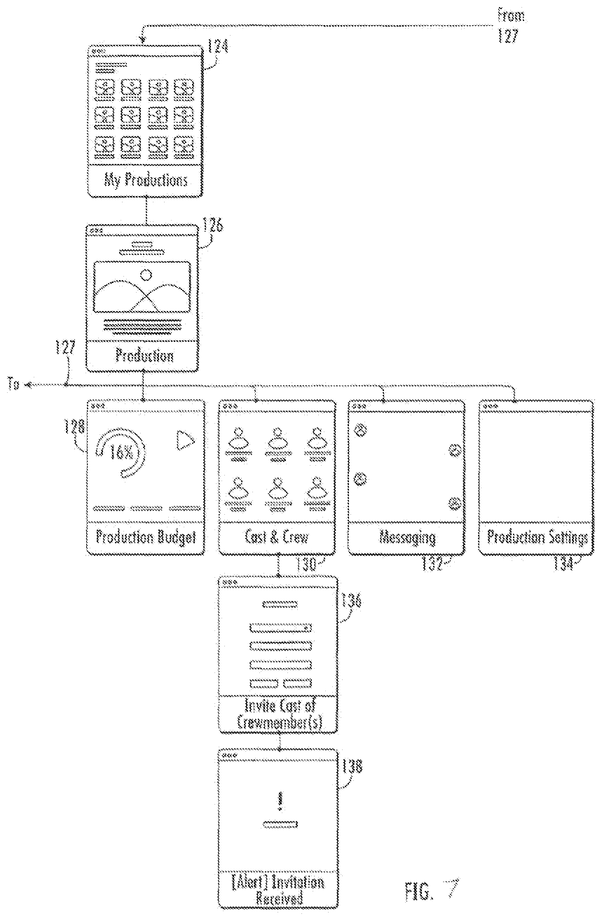

Referring now to FIG. 7, once the user has login success, then a screen displaying my productions 124 is shown and the user can then select a production 126. The user continues to be able to select from several options such as production budget 128, cast & crew 130, messaging 132, and production settings 134. If the user selected a particular cast and crew 134, then the user is presented with an invite cast or crewmembers screen 136. Subsequently, once the invitation is received an alert is displayed 138.

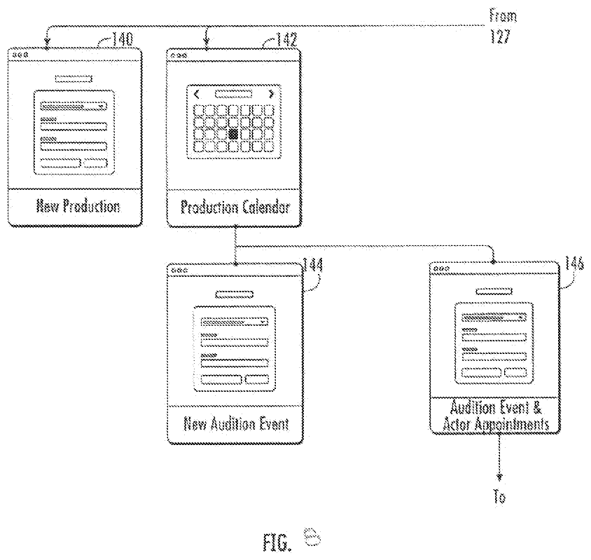

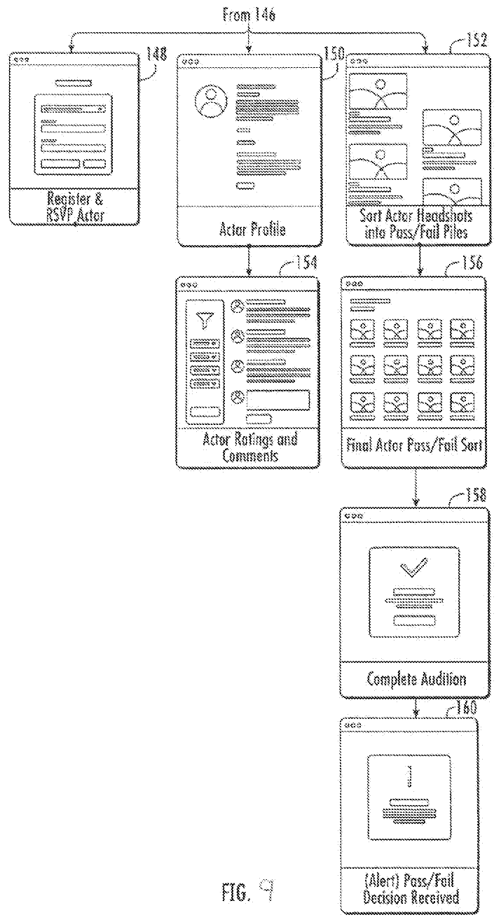

Referring now to FIG. 8, the user can initiate a new production 140 and view the production calendar 142. In addition, the user can create a new audition event 144 and view all the scheduled audition event and actor appointments 146. The user can continue and register and RSVP action 148, view the actor profile 150, and sort actor headshots into pass/fail piles 152, as illustrated in FIG. 9. The user can also add and view actor ratings and comments 154, and view a final actor pass/fail sort 156. The audition is indicated as complete 158 and an alert is displayed when the pass/fail decision is received 160 by the actor.

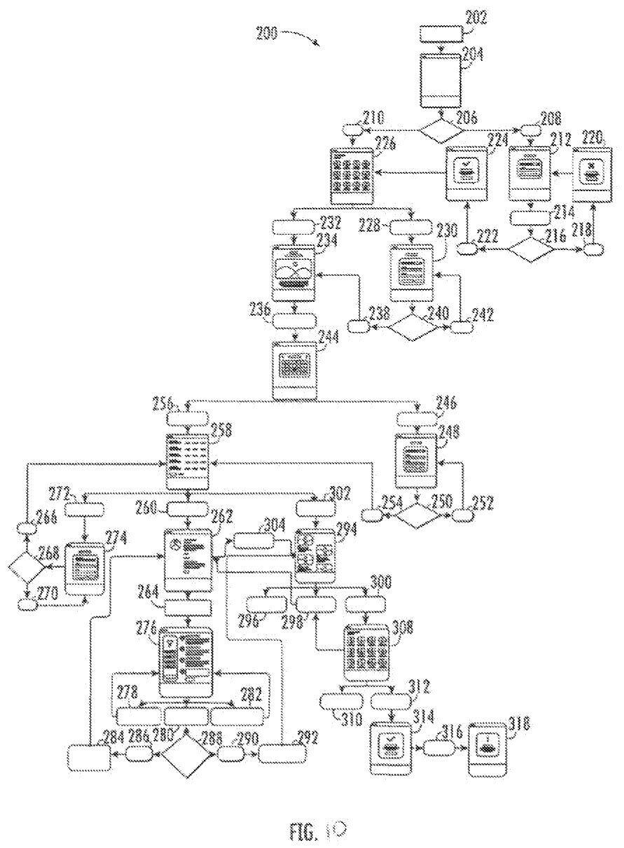

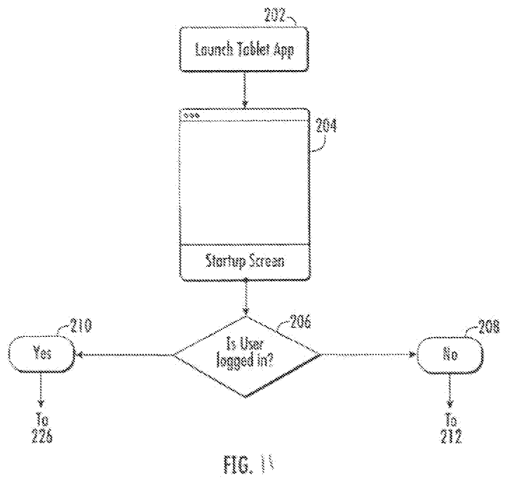

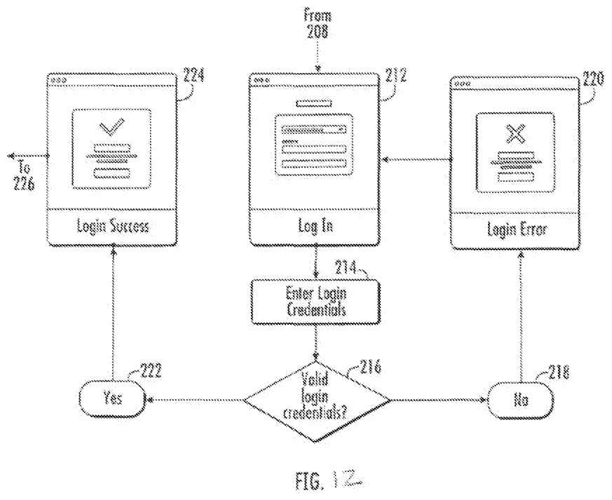

Referring now to FIG. 10, a flow diagram of a casting director messaging and alert method is disclosed and generally designated 200. The method 200 begins, at 202, where the tablet application is launched and a startup screen 204 is displayed to the user as shown in FIG. 11. If the user is logged in, at 206, then the method continues to 210. If the user is not logged in, then the method continues to 208. Referring now to FIG. 12, an interface is displayed to the user, at 212, for the user to log in. The user can enter login credentials, at 214 where it is determined whether the login credentials are valid, at 216. If the login credentials are not valid, then the, at 218, the method displays a login error screen 220 and takes the user back to the log in screen 212 to try again. If the login credentials were determined to be valid, at 216, then the method continues to 222 where a login success 224 screen is displayed to the user.

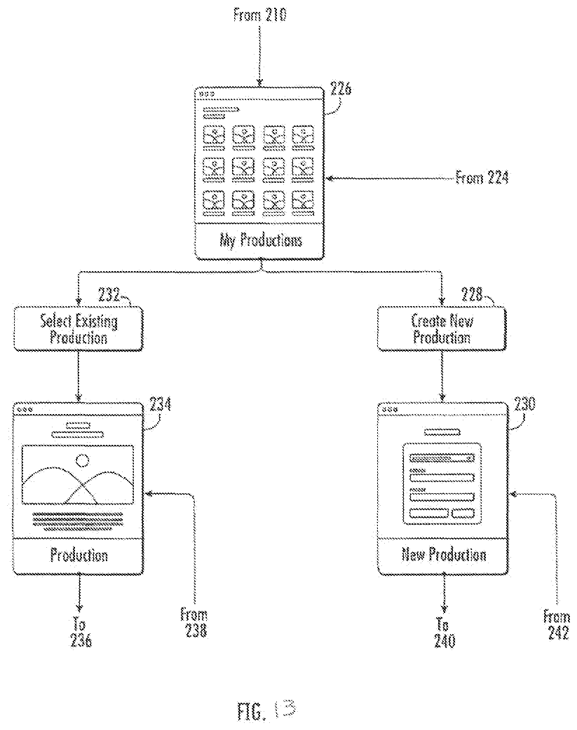

Once the user is logged in, a productions interface 226 is displayed, as illustrated in FIG. 13. The user can then continue to either select an existing production, at 232, or create a new production, at 228. If the user selects an existing production, then the production screen 234 is displayed. Alternatively, if the user selects to create a new production, then a new production interface 230 is displayed for the user to enter the required information.

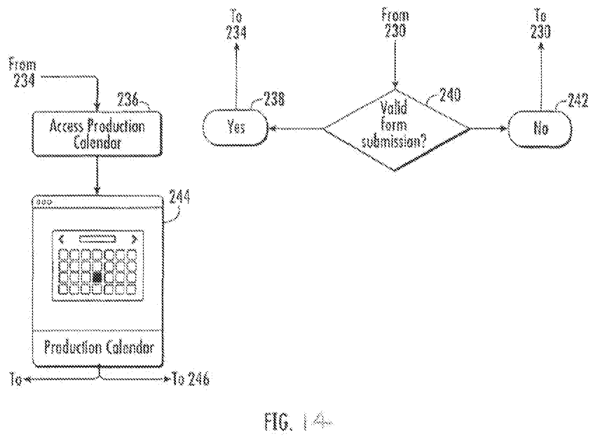

Referring now to FIG. 14, the user can access the production calendar, at 236, which is displayed on the production calendar 244 screen. Still referring to FIG. 14, the new production form submission is determined whether it is valid, at 240, and if not, at 242, the user is directed back to the new production screen 230. If the new production submission is determined to be valid, the method moves to 238 and the production 234 screen is displayed to the user (see FIG. 13).

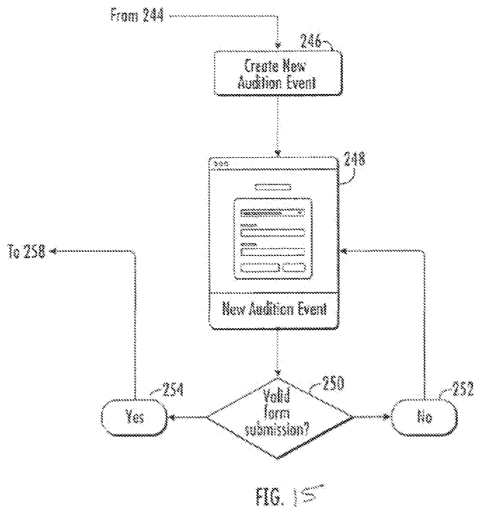

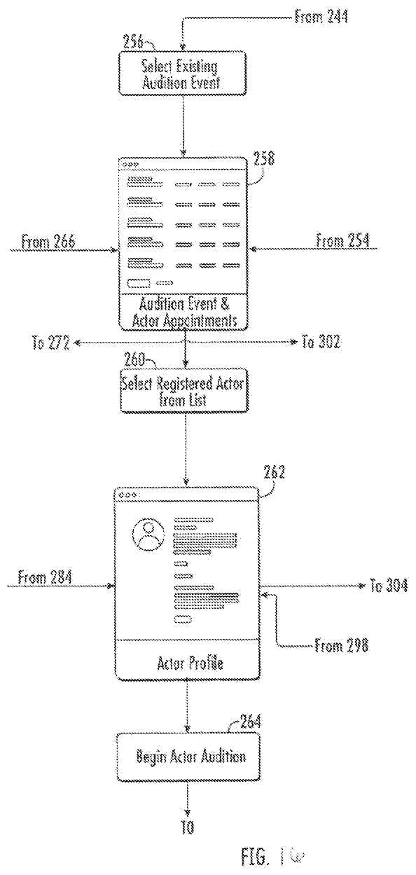

A new audition event is created, at 246, using the new audition event 248 screen, as shown in FIG. 15. The method determines, at 250, whether the new auditions submission is valid, and if not, at 252, the user is returned to the new audition event 248 screen. If the new audition submission is valid, at 254, the method Continues to an audition event & actor appointments 258 screen shown in FIG. 16.

Still referring to FIG. 16, the user can select an existing audition event, at 256, which also brings the user to the audition event & actor appointments 258 screen. The user can select a registered actor from the list, at 260, which then displays the actor profile 262. Once the actor profile 262 is displayed on the screen, the audition can begin, at 264.

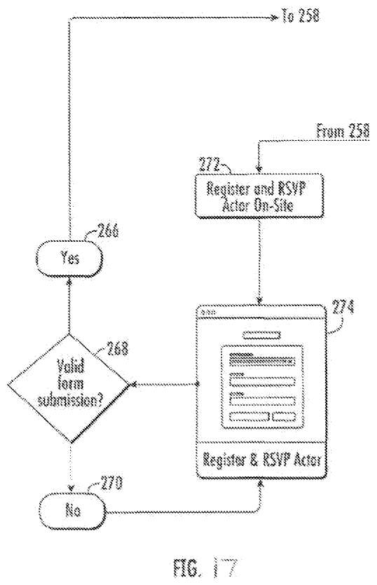

Referring now to FIG. 17, the user can register and RSVP actor on-site, at 272, and use interface 274. If the form submission is valid, at 268, then the user is returned to the audition event & actor appointments 258 screen. If the form submission is not valid, at 270, then the user is returned to the register & RSVP actor 274 Screen.

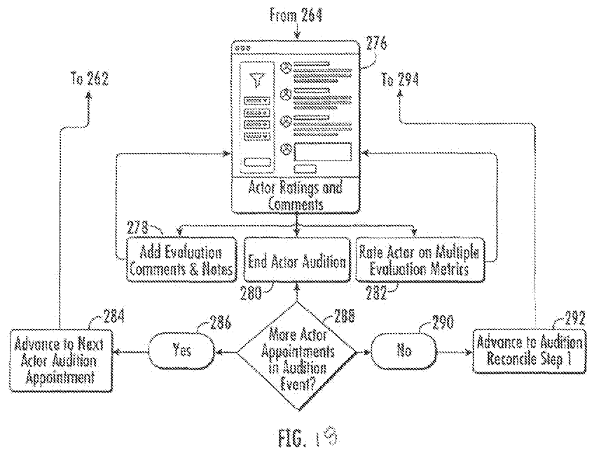

Referring now to FIG. 18, once the audition begins, the user is presented with an actor ratings and comments interface 276. The user can add evaluation comments and notes, at 278, and rate the actor on multiple evaluation metrics, at 282. Once the audition is ended, at 280, the method determines whether there are more actor appointments in the audition event, at 288. If not, at 290, the method moves to advance to audition reconcile step 1, at 292. If it is determined, at 288, that there are more actor appointments, at 286, the method moves to advance to the next actor audition appointment, at 284.

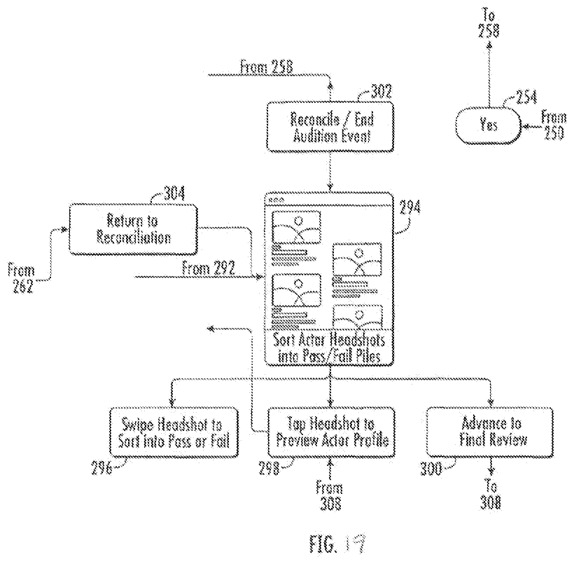

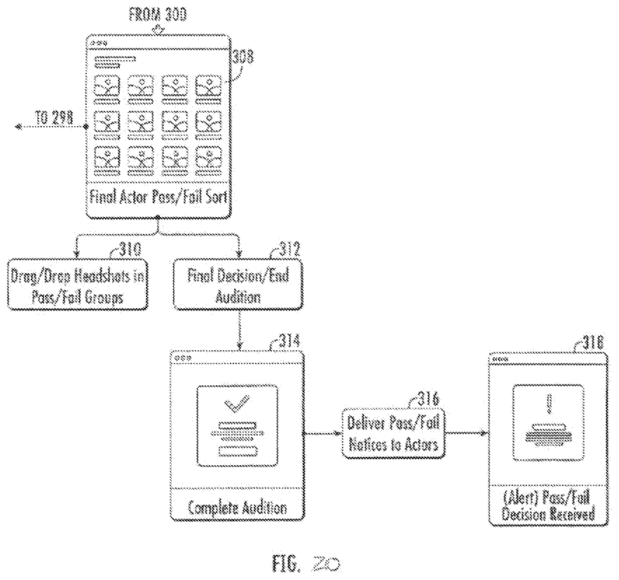

Referring now to FIG. 19, a sorting actor headshots into pass/fail piles interface 294 is used once the reconcile/end audition event, at 302, has ended. The user can tap a headshot to preview the actor profile, at 298. The user can also swipe headshots to sort into pass or fail, at 296, or advance to final review, at 300. This process continues in order to narrow down the number of actors to the final sort where the user is presented with the final actor pass/fail sort, at 308, as shown in FIG. 20.

The user can drag/drop headshots in the pass/fail groups, at 310. Once the headshots are sorted, the user can make final decisions/end auditions, at. 312, and complete the audition 314. The method also includes delivering pass/fail notices to the actors, at 316, and an alert is displayed when the pass/fail decision is received 318 by the actor.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A casting director messaging and alert system, the system comprising:
a memory;
a plurality of actor characteristic models corresponding to a respective plurality of productions, the plurality of actor characteristic models stored in the memory;
one or more processors coupled to the memory and configured to execute computer-readable programming instructions to perform operations comprising:
transmitting to a first mobile computing device the plurality of productions stored in the memory to the user;
prompting, via a graphical user interface on the first mobile computing device, the user to select one of the productions from the plurality of productions;
receiving from the first mobile computing device the selected production;
comparing data, by a machine intelligence application running on the one or more processors, of available actors to the respective actor characteristics model for the selected production;
determining which of the available actors are predicted actors by using probabilistic neural network algorithms that compare the data of the available actors to the respective actor characteristics model;
transmitting to the first mobile device, in response to determining the predictive actors, pictures of the predictive actors corresponding to the selected production and stored in the memory;
prompting, via the graphical user interface on the first mobile computing device, the user to select at least one of the predictive actors:
transmitting, to a second mobile computing device corresponding to the at least one selected predictive actor, an electronic invitation having a unique code for an appointment to an audition for the selected production;
receiving from the second mobile device of the selected predictive actor an invitation response to the electronic invitation;
generating, in response to receiving the audition response from the selected predictive actor, an electronic ticket that comprises the unique code for entry to the appointment by the selected predictive actor; and
transmitting the electronic ticket to the second mobile computing device of the selected predictive actor.

2. The system of claim 1, wherein the operations further comprise scanning the electronic ticket displayed on the second mobile computing device to determine if it matches the electronic invitation when presented to the first mobile computing device at the audition.

3. The system of claim 2, wherein the operations further comprise displaying a plurality of profiles associated with the predictive actors on the first mobile computing device.

4. The system of claim 3, wherein the operations further comprise prompting, via the graphical user interface on the first mobile computing device, the user to tag the pictures into a first pass category or a second fail category after the audition and provide feedback from the audition.

5. The system of claim 4, wherein the operations further comprise transmitting, to the second mobile computing device corresponding to the at least one selected predictive actor, an electronic audition decision corresponding to the tagged category, the electronic audition decision having a textual message generated using artificial intelligence prompted by the feedback from the audition.

6. The system of claim 5, wherein the operations further comprise receiving from the second mobile device of the selected predictive actor an audition response to the audition decision.

7. The system of claim 1, wherein the invitation response comprises an alert automatically displayed on the first mobile computing device when received.

8. The system of claim 1, wherein the probabilistic neural network algorithms are programmed to include non-traditional gender castings in determining which of the available actors are predicted actors.

9. The system of claim 1, wherein the operations further comprise sending and receiving user messaging, via the graphical user interface of the first mobile computing device, with the plurality of actors.

10. The system of claim 1, wherein the operations further comprise generating a calendar to display on the first mobile computing device of each audition appointment.

11. The system of claim 1, wherein the operations further comprise generating a resume using artificial intelligence in response to verbal input from one of the available actors, the resume stored in the date of available actors.

12. The system of claim 1, wherein the operations further comprise generating an audition for the selected production using artificial intelligence.

13. A computer implemented casting director messaging and alert method, the method comprising:
transmitting to a first mobile computing device a plurality of productions stored in a memory in response to receiving, by a machine intelligence application running on one or more processors, a request from a user;
prompting, via a graphical user interface on the first mobile computing device, the user to select one of the productions from the plurality of productions;
receiving from the first mobile computing device the selected production;
comparing, by the machine intelligence application, data of available actors to a respective actor characteristics model for the selected production;
transmitting to the first mobile device, in response to determining which of the available actors are predicted actors by using probabilistic neural network algorithms that compare the data of the available actors to the respective actor characteristics model;
prompting, via the graphical user interface on the first mobile computing device, the user to select at least one of the predictive actors;
transmitting, to a second mobile computing device corresponding to the at least one selected predictive actor, an electronic invitation having a unique code for an appointment to an audition for the selected production;
receiving from the second mobile device of the selected predictive actor an invitation response to the electronic invitation;
generating, in response to receiving the audition response from the selected predictive actor, an electronic ticket that comprises the unique code for entry to the appointment by the selected predictive actor; and
transmitting the electronic ticket to the second mobile computing device of the selected predictive actor.

14. The method of claim 13, further comprising scanning the electronic ticket displayed on the second mobile computing device to determine if it matches the electronic invitation when presented to the first mobile computing device at the audition.

15. The method of claim 14, further comprising displaying a plurality of profiles associated with the predictive actors on the first mobile computing device.

16. The method of claim 15, further comprising prompting, via the graphical user interface on the first mobile computing device, the user to tag the pictures into a first pass category or a second fail category after the audition and provide feedback from the audition.

17. The method of claim 16, further comprising transmitting, to the second mobile computing device corresponding to the at least one selected predictive actor, an electronic audition decision corresponding to the tagged category, the electronic audition decision having a textual message generated using artificial intelligence prompted by the feedback from the audition.

18. The method of claim 17, further comprising receiving from the second mobile device of the selected predictive actor an audition response to the audition decision.

19. A non-transitory machine-readable medium having stored thereon machine-readable instructions executable to cause operations comprising:
transmitting to a first mobile computing device a plurality of productions stored in a memory in response to receiving, by a machine intelligence application running on one or more processors, a request from a user;
prompting, via a graphical user interface on the first mobile computing device, the user to select one of the productions from the plurality of productions;
receiving from the first mobile computing device the selected production;
comparing by the machine intelligence application data of available actors to a respective actor characteristics model for the selected production;
transmitting to the first mobile device, in response to determining the predictive actors, pictures of the predictive actors corresponding to the selected production and stored in the memory;
prompting, via the graphical user interface on the first mobile computing device, the user to select at least one of the predictive actors;
transmitting, to a second mobile computing device corresponding to the at least one selected predictive actor, an electronic invitation having a unique code for an appointment to an audition for the selected production;
receiving from the second mobile device of the selected predictive actor an invitation response to the electronic invitation;
generating, in response to receiving the audition response from the selected predictive actor, an electronic ticket that comprises the unique code for entry to the appointment by the selected predictive actor; and
transmitting the electronic ticket to the second mobile computing device of the selected predictive actor.

20. The non-transitory machine-readable medium of claim 19, wherein the operations further comprise:
scanning the electronic ticket displayed on the second mobile computing device to determine if it matches the electronic invitation when presented to the first mobile computing device at the audition;
displaying a plurality of actor profiles associated with the predictive actors on the first mobile computing device;
prompting, via the graphical user interface on the first mobile computing device, the user to tag the pictures into a first pass category or a second fail category after the audition and provide feedback from the audition;
transmitting, to the second mobile computing device corresponding to the at least one selected predictive actor, an electronic audition decision corresponding to the tagged category, the electronic audition decision having a textual message generated using artificial intelligence prompted by the feedback from the audition; and
receiving from the second mobile device of the selected predictive actor an audition response to the audition decision.
